(19) United States
(12) Patent Application Publication
(10) Pub. No.: US 2012/0109876 A1
(43) Pub. Date: May 3, 2012

(54) Long-term global anonymous medical health records repository

(76) Inventor: Paul R. Ganichot, Tampa, FL (US)

(21) Appl. No.: 12/916,566

(22) Filed: Oct. 31, 2010

(51) Int. Cl. G06F 17/30

(52) U.S. Cl. 707/600; 707/792; 707/E17.005

(57) ABSTRACT

This invention provides a very large, long term, universal, and global repository of health records for knowledge preservation, statistical sample analysis, and querying, without personally identifiable patient information. Embodiments of this invention provide a computerized system consisting of a very large number—thousands to billions—of health records, with long-term medical history—spanning several years to several decades—, obtained from diverse health care providers, stored in read-only mode in a global repository, without accessible personally identifiable patient information, and with the corresponding means to query, correlate, trend, and analyze the data.

This invention provides a very large, long term, universal, and global repository of health records for knowledge preservation, statistical sample analysis, and querying, without personally identifiable patient information. Embodiments of this invention provide a computerized system consisting of a very large number—thousands to billions—of health records, with long-term medical history—spanning several years to several decades—, obtained from diverse health care providers, stored in read-only mode in a global repository, without accessible personally identifiable patient information, and with the corresponding means to query, correlate, trend, and analyze the data.

### BACKGROUND OF THE INVENTION

Automated medical diagnosis systems and health record databases are typically defined and built with a specific application or medical condition goal. Typical constrained scope medical systems are shown, for example, in the following patents:
U.S. Pat. No. 7,523,042 Hunt, et al.
U.S. Pat. No. 7,617,078 Rao, et al.
U.S. Pat. No. 6,523,009 Bobbi L. Wilkins
20090299767 Michon; Francis ; et al.
U.S. Pat. No. 7,672,987 Mukherjee, et al.
U.S. Pat. No. 7,574,370 Mayaud
U.S. Pat. No. 7,606,723 Mayaud
20040243586 Byers, Frank Hugh
U.S. Pat. No. 7,181,375 Rao, et al.
U.S. Pat. No. 6,915,265 Johnson
U.S. Pat. No. 7,593,952 Soll, et al.
20080147438 Kil; David H.
20090228303 Faulkner; Judith R.; et al.
20070203754 Harrington; David Glenn; et al.
U.S. Pat. No. 7,634,563 Cody Menard et al
U.S. Pat. No. 7,278,579 Cathy A. Loffredo et al
U.S. Pat. No. 7,318,059 Denise Marie Thomas et al
U.S. Pat. No. 5,664,109 Gary Duane Johnson et al
U.S. Pat. No. 5,301,105 Desmond D. Cummings et al

These systems all have their benefit and specific purpose, however there is a lack of global repository designed to accumulate medical health records over the long term, without any constraint on application, medical condition, or provider, and without storing—or with complete segregation of—personally identifiable information rendering the medical health records totally anonymous.

### SUMMARY OF THE INVENTION

The present invention provides a means to capture knowledge and experience related to a very large number of health records over the long term. Whereas a physician or group of physicians can only accumulate a limited amount of knowledge and experience, typically limited to several hundreds to a few thousands of patients' health records, this invention provides the means to store millions of patients' health records and query, correlate, trend, and analyze these records.

The system, in order to keep the focus on the medical aspects of the health records, removes the personally identifiable patient information from the main repository therefore rendering the health records anonymous. For example, a patient's name, address, social security number, date of birth are removed.

It is thus a feature of at least one embodiment of the invention to maintain or extrapolate demographic and socio-economic information to provide critical context information for the health records. For example, age, income category, and zip code information is maintained or extrapolated.

Consequently the present invention includes a repository of anonymous health records.

In the invention, the system operates to:
a. Remove or segregate patients' personally identifiable information to prevent correlation of health records to specific individuals.
b. Leverage one or more staging areas to remove patients' personally identifiable information data and assign a unique correlation identifier to identify the patient.
c. Correlate health records via a system generated correlation identifier unrelated to any patient information.
d. Prevent reverse traceability from the correlation identifier to personally identifiable patient information.

An embodiment of this invention may host the above mentioned staging areas into completely segregated databases either located at the health providers' site or other secured and access restricted locations.

The system may compile health records from one or more health care providers, domestically and internationally, for storage in read-only mode in a global repository.

The system further operates to:
a. Generate or handle a health record provider identifier for each provider.
b. Link the appropriate health record provider identifier to each health record.
c. Assign a quality and reliability index to each health provider.
d. Update the health providers' quality and reliability index on a regular basis.
e. Tracks the history of updates of health providers' quality and reliability index.

It is thus a feature of at least one embodiment of the invention for the repository to include one or more databases and one or more data warehouses of symptoms, diagnosis, analysis, prescriptions, side-effects, and medicines.

A system repository's embodiment may leverage the Unified Medical Language System and other pertinent data formatting or interface specifications as necessary to accept health record data feeds from providers.

Further, embodiments of this invention may include the capacity and scalability means to utilize this repository to preserve health records for knowledge and experience sharing via vertical scaling, horizontal scaling, co-location, or distribution of the computerized systems.

The invention further provides the means to perform large statistical sample analysis of health records based on any combination of the data stored and leveraging relevant methods such as statistical inference and descriptive statistics.

An embodiment of this invention may include the means to identify patterns and trends on small, middle, or large scale of health records, or any pertinent combination via the implementation of the relevant querying and analysis features.

It is thus a feature of at least one embodiment of the invention to provide analysis of the anonymous health records via:
a. Pre-defined reports and charts.
b. Customizable reports and charts.
c. Generation of additional data storage, views, or dimensions.
d. Rule-based analysis,
e. Computerized user interface with synchronous or asynchronous transactions to health records repository.

### References

Bodenreider, Olivier. (2004) The Unified Medical Language System (UMLS): integrating biomedical terminology. Nucleic Acids Research, 32, D267-D270.
Browne, McCray and Srinivasan (2000). The Specialist Lexicon. Lister Hill National Center for Biomedical Communications, National Library of Medicine, Bethesda, Md., p. 1.
Kumar, Anand and Smith, Barry (2003) The Unified Medical Language System and the Gene Ontology: Some Critical Reflections, in: KI 2003: Advances in Artificial Intelligence (Lecture Notes in Artificial Intelligence 2821), Berlin: Springer, 135-148.
Smith, Barry Kumar, Anand and Schulze-Kremer, Steffen (2004) Revising the UMLS Semantic Network, in M. Fieschi, et al. (eds.), Medinfo 2004, Amsterdam: IOS Press, 1700.
Coiera, Enrico. (2003) Guide to Health Informatics, 2nd ed. Chapter 17-Healthcare terminologies and classification systems

What is claimed is:

1. A computerized system consisting of a very large—thousands to billions—, long term—several years to several decades—, universal, and global repository of health records without accessible personally identifiable patient information.

2. The system of claim 1 in which said health records are compiled from one or more health care providers, domestically and internationally, and stored in a read-only mode in a global repository.

3. The system of claim 1 in which said repository includes one or more database and one or more data warehouse of symptoms, diagnosis, analysis, prescriptions, side-effects, and medicines.

4. The system of claim 1 in which said repository includes socio-economic and demographic information.

5. The system of claim 1 including a provision for implementation using the Unified Medical Language System.

6. The system of claim 1 in which said health records are correlated via a system generated correlation identifier unrelated to any patient information.

7. The system of claim 1 including means to remove or segregate patients' personally identifiable information to prevent correlation of health records to specific individuals.

8. A system according to claim 7 in which said means include provision to leverage a staging area to remove patients' personally identifiable information data and assign a unique correlation identifier.

9. A system according to claim 8 in which said staging area includes provision for hosting into a completely segregated database either located at the health providers' site or other secured and access restricted locations.

10. A system according to claim 6 in which said correlation identifier includes means to prevent reverse traceability to personally identifiable patient information.

11. A system according to claim 2 in which said health provider identification is linked to the health record.

12. A system according to claim 2 in which said health provider is assigned a quality and reliability index with provision for updates on a regular basis and the tracking of such index updates.

13. The system of claim 1, including provision for utilization of this repository to preserve health records for knowledge and experience sharing.

14. The system of claim 1, including means for providing large statistical sample analysis of health records such as statistical inference and descriptive statistics.

15. The system of claim 1, including means for identifying patterns and trends on small, middle, and large scale of health records from the said repository.

16. The system of claim 1, including means for refining medical diagnosis and/or recommend prescription such as pre-defined reports and charts, customizable reports and charts, generation of additional data storage, views, or dimensions, rule-based analysis, and computerized user interface with synchronous or asynchronous transactions to health records repository.

17. The system of claim 1, include a set of universal interfaces such as the Unified Medical Language System and other pertinent data formatting or interface specifications as necessary to accept health record data feeds from providers.
